(19) United States
(12) Patent Application Publication
(10) Pub. No.: US 2025/0027221 A1
(43) Pub. Date: Jan. 23, 2025

(54) ELECTROLYSIS APPARATUS FOR THE PRODUCTION OF IRON WITH AN IMPROVED IRON OXIDE SUPPLY DEVICE

(71) Applicant: ArcelorMittal, Luxembourg (LU)

(72) Inventor: Hervé LAVELAINE DE MAUBEUGE, Metz (FR)

(21) Appl. No.: 18/714,254

(22) PCT Filed: Dec. 15, 2021
(86) PCT No.: PCT/IB2021/061745

§ 371 Date: May 29, 2024

(51) Int. Cl. C25C 1/06; C25C 7/02; C25C 7/06

(52) U.S. Cl. CPC C25C 1/06; C25C 7/02; C25C 7/06

(57) ABSTRACT

An apparatus (1) for the production of iron through reduction of iron ore by an electrolysis reaction, wherein the supply to supply iron ore includes a twin-screw supplier (32) provided to discharge iron ore powder (46) into an electrolyte feed pipe (31) upstream of the electrolytic chamber (6).

The invention is related to an apparatus to produce iron by an electrolysis process.

### BACKGROUND

Steel can be currently produced at an industrial scale through two main manufacturing routes. Nowadays, the most commonly used production route consists in producing pig iron in a blast furnace, by use of a reducing agent, mainly coke, to reduce iron oxides. In this method, approx. 450 to 600 kg of coke is consumed per metric ton of pig iron. This method, both in the production of coke from coal in a coking plant and in the production of pig iron, releases significant quantities of CO₂.

The second main route involves so-called “direct reduction methods”. Among them are methods according to the brands MIDREX, FINMET, ENERGIRON/HYL, COREX, FINEX etc., in which sponge iron is produced in the form of HDRI (Hot Direct Reduced Iron), CDRI (cold direct reduced iron), or HBI (hot briquetted iron) from the direct reduction of iron oxide carriers. Sponge iron in the form of HDRI, CDRI, and HBI usually undergo further processing in electric arc furnaces. Even if this second route emits less CO2 than the previous one it still releases some and relies moreover on carbon fossil fuels.

Current developments thus focus on methods allowing to produce iron which release less or even no CO₂ and which is carbon-neutral.

A known alternative method to produce steel from iron ores is based on electrochemical techniques. In such techniques, iron is produced from iron oxide using an electrolyser unit comprising two electrodes—an anode and a cathode—connected to a source of electric current, an electrolyte circuit and an iron oxide entry into the electrolyser unit. The anode and cathode are constantly immersed in the circulating electrolyte in order to ensure good electrical conduction between said electrodes. The electrolytic reaction produces pure iron plates on the cathode and gaseous oxygen. Iron plates thus obtained may be then melted with other elements such as carbon-bearing materials and scrap in electrical furnaces to produce steel.

### SUMMARY OF THE INVENTION

The continuous and automated supply of iron oxide into the electrolyte is a key component. The supply system must provide iron oxide solid particles at the rate of their consumption by the electrolyte. A loss of control of iron oxide content in the electrolyte would lead a reduction the faradaic yield and thus to a detrimental effect on the productivity of the cell. One of the problems of such control is due to the propension of iron oxide to turn pasty and sticky when wetted, especially when put on metal surfaces.

One solution would be to stir iron oxide with a liquid before supplying the suspension in the electrolyte, but this would lead to the incorporation of air into the liquid, which is to be avoided due to alkaline neutralization by carbonation from carbon dioxide in the atmosphere. Furthermore, when such stirring is manually operated, this operation is dangerous due to the proximity to the alkaline electrolyte.

An object of the present invention is to remedy the drawbacks of the prior art by providing an improved oxide supply device able to automatically discharge iron oxide powder in the electrolyte in a precisely controlled way while preventing any air contact with the powder. The aim of the invention is also to provide such device which is easy to manufacture and cost effective.

The apparatus of the invention comprises a casing including a gas-permeable anode plate, a cathode plate, both facing each other and being separated by an electrolyte chamber. The casing further includes a degassing unit comprising a gas recovery part extending along the opposite side of the gas-permeable anode plate to the chamber, said casing being provided with means for circulating an electrolyte within the electrolyte chamber which comprises and electrolyte inlet and an electrolyte outlet, and with means to supply iron ore to said electrolyte chamber, said means to supply iron ore to said electrolyte chamber comprising a twin-screw supplier provided to discharge iron ore powder into an electrolyte feed pipe in fluidic connection with the electrolyte inlet, said twin-screw supplier comprising two screws parallel to each other inside a barrel, maintaining a shaft distance A between them and rotating in opposite directions while said two screws engage with each other, said barrel extending from screw rotating drive means to a discharge opening immersed in the electrolyte flowing through the electrolyte feed pipe, and comprising an iron ore powder feed opening, said iron ore powder feed opening being connected to iron ore powder feed means.

The apparatus of the invention may also include the following optional characteristics considered individually or according to all possible combination of techniques:
the screws are arranged parallel to the force of gravitational attraction,
the electrolyte feed pipe is arranged perpendicular to the screws,
the surface of the two screws is smooth,
the two screws are twin-concave coarse screws,
the ratio between the screw diameter (D) and the screw pitch (B) of each screw is comprised between 0.8 to 1.2,
the internal surface of the barrel is rough and arranged in mechanical contact with the screws,
the barrel is under nitrogen atmosphere,
the iron ore powder feed means comprise a pinch valve,
the apparatus is supplied by renewable energy.

### BRIEF DESCRIPTION OF THE DRAWINGS

Other characteristics and advantages of the invention will be apparent in the below descriptions, by way of indication and in no way limiting, and referring to the annexed figures among which:

FIG. 1, which represents a longitudinal section view of an apparatus according to the invention including the twin-screw supplier schematically illustrated,

FIG. 2, which represents a front view of the twin-screw supplier arranged to discharge iron ore powder into the electrolyte feed pipe,

FIG. 3, which represents a perspective view of the end portion of the two screws of the twin-screw supplier, and

FIG. 4, which represents a front view of the two screws of the twin-screw supplier engage with each other.

### DETAILED DESCRIPTION

First, it is noted that on the figures, the same references designate the same elements regardless of the figure on which they feature and regardless of the form of these elements. Similarly, should elements not be specifically referenced on one of the figures, their references may be easily found by referring oneself to another figure.

It is also noted that the figures represent mainly one embodiment of the object of the invention but other embodiments which correspond to the definition of the invention may exist.

The invention refers to an apparatus 1 provided for the production of iron metal (Fe) through the reduction of iron ore, containing notably hematite (Fe₂O₃) and other iron oxides or hydroxides, by an electrolysis reaction. Said chemical reaction is well known and is notably described in the case of hematite by the following equation (1):

$${Fe}_{2} {O}_{3} ↔ 2 Fe + \frac{3}{2} {O}_{2} \qquad ( 1 )$$

The electrolysis reaction thus emits gases—mainly oxygen—that must be extracted from the apparatus 1.

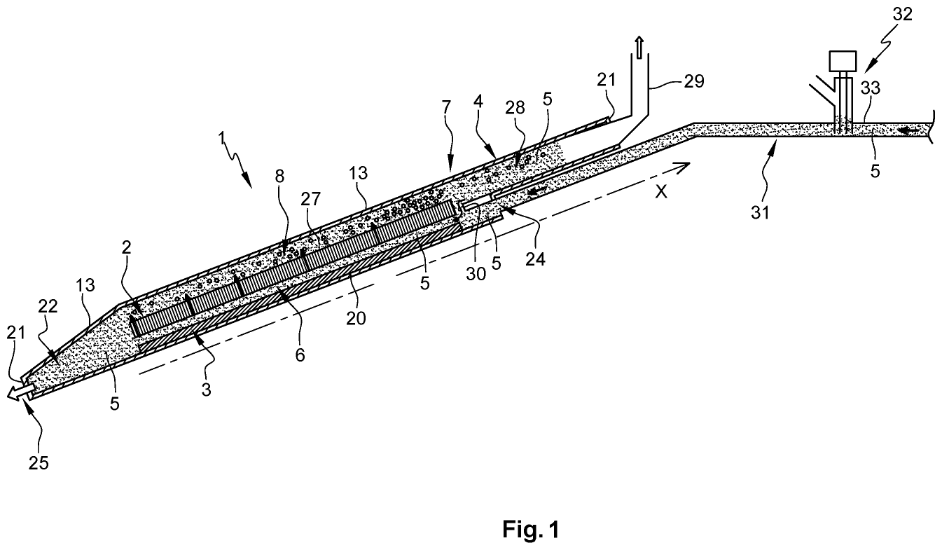

With reference to FIG. 1, the apparatus 1 comprises a casing 4 extending along a longitudinal axis X in which the electrolysis reaction occurs. Said casing 4 is delimited by a base plate 20, a cover plate 13 and two lateral plates 21. In addition, the casing includes a gas permeable anode plate 2 intended to be totally immersed in an electrolyte 5 and a cathode plate 3, both plates facing each other and being kept at required distance with fastening means. The casing 4 also includes an electrolyte chamber 6 extending longitudinally between the anode plate 2 and the cathode plate 3 up to an evacuation chamber 22. The apparatus 1 finally comprises an electrical power source connected to the anode plate 2 and the cathode plate 3.

In a preferred embodiment this electrical power source uses renewable energy which is defined as energy that is collected from renewable resources, which are naturally replenished on a human timescale, including sources like sunlight, wind, rain, tides, waves, and geothermal heat. In some embodiments, the use of electricity coming from nuclear sources can be used as it is not emitting CO2 to be produced. This further limit the CO2 footprint of the iron production process.

In order to produce iron through the electrolysis reaction, the electrolyte 5—preferably a water-based solution like, for example a sodium hydroxide aqueous solution—flows through the casing 4 inside the electrolyte chamber 6 while the apparatus 1 is operating. The apparatus 1 thus comprises means for circulating the electrolyte which comprises, for example, an electrolyte circuit connected to an inlet 24 and an outlet 25 managed in the casing 4 and both fluidically connected to the electrolyte chamber 6. Iron ore is introduced into the apparatus 1 as a powder suspension within the electrolyte 5 through the inlet 24 as it will further described.

During the electrolysis reaction, oxidised iron is reduced to iron according to reaction (1) and reduced iron is deposited on the cathode plate 3 while gaseous oxygen is emitted inside the casing 4. Since this gas is an electrical insulator, it prevents the good working of the electrolysis reaction and must be continuously evacuated outside of the casing 4.

For this purpose, the casing 4 includes a degassing unit 7 comprising a gas recovery part 8 extending longitudinally along the opposite side 27 of the anode plate 2 to the electrolyte chamber 6. This gas recovery part 8 is a compartment provided to be filled with the electrolyte 5 and disposed between the anode plate 2 and the cover plate 13. Said gas recovery part 8 is thus provided to recover gases escaping through the anode plate 2.

As depicted in FIG. 1, the degassing unit 7 also comprises an electrolyte recirculation part 28 extending in continuity with the gas recovery part 8 up to a gas outlet 29 managed in the casing 4. The electrolyte recirculation part 28 is provided to be at least partly filled with the electrolyte 5. In addition, said recirculation part 28 is in fluidic connection with the electrolyte chamber 6. When the apparatus 1 is operating, the recirculation part 28 allows the electrolyte 5 flowing from the gas recovery part 8 to be redirected towards the electrolyte chamber 6 for example via an elbow duct 30 which is adjacent to the anode plate 2 and fluidically connected to the electrolyte chamber 6.

As illustrated in FIG. 1 and according to the invention, means to supply iron ore to the electrolyte chamber 6 comprise a twin-screw supplier 32 located onto an electrolyte feed pipe 31 in fluidic connection with the electrolyte inlet 24. The twin-screw supplier 32 crosses the wall 33 of the electrolyte feed pipe 31 to discharge the iron ore powder into the electrolyte flow 5.

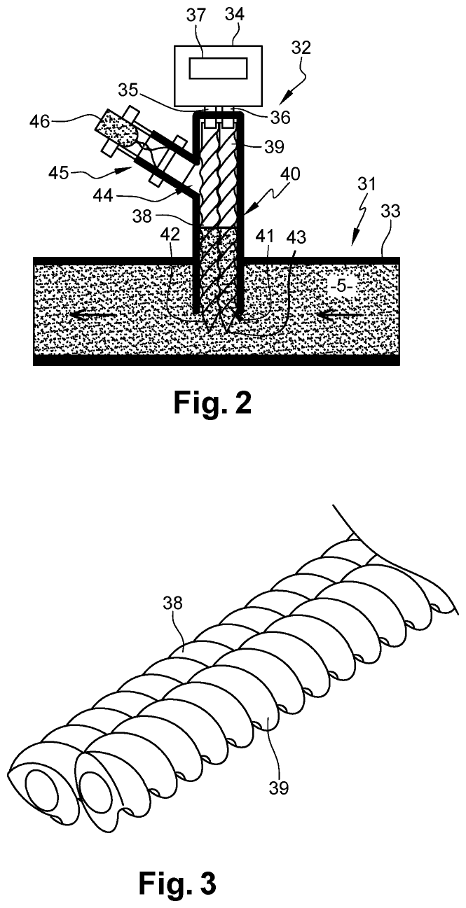

Referring to FIG. 2, the twin-screw supplier 32 comprises a gearbox 34 which comprises two output shafts 35,36 provided parallel to each other, maintaining a certain shaft distance between them and rotating in the opposite direction. The gearbox 34 delivers the torque obtained from a drive motor 37 connected to the gearbox 34 to two screws 38,39 through the output shafts 35,36.

The basal portions of the two screws 38,39 are connected to the output shaft 35,36 while their opposite free portions 42,43 are immersed in the electrolyte 5 flowing through the electrolyte feed pipe 31.

The two screws 38,39 are provided parallel in a barrel 40, maintaining the shaft distance between them. The two screws 38,39 thus rotate in the opposite direction inside of the barrel 40 while they are engaged with each other.

The barrel 40 extends from the gear box 34 to a discharge opening 41 immersed in the electrolyte 5. The free portions 42,43 of the two screws 38,39 are located at the discharge opening 41. The dimensions of the barrel 40 are adapted to the dimensions of the two screws 38,39 with a small mechanical clearance between the screws 38,39 and the barrel 40 for a low free surface of the electrolyte 5. The electrolyte 5 is therefore able to rise in the barrel 40 at least up to the level of the wall 33 of the electrolyte feed pipe 31 thereby defining a dry conveyed area and a wet conveyed area allowing to discharge the iron oxide powder into the electrolyte 5 in a non-agglomerated state.

The internal surface of the barrel 40 is advantageously rough and rifted with counter rotating spirals to provide a high friction with the two screws 38,39 in opposite rotation. This allows to prevent bridges and cavities to be formed.

The barrel 40 comprises an iron feed opening 44 through which the iron oxide powder 46 is discharged inside of the barrel 40 on the surface of the two screws 38,39 which rotate in the opposite direction, thus conveying the iron oxide powder 46 up to the discharge opening 41.

The iron feed opening 44 is connected to a valve 45, for example a pinch valve, through which the iron oxide powder 46 is supplied up to the iron feed opening 44.

The iron feed opening 44 is located above the maximum level of electrolyte inside the barrel 40 when operating. Such location allows to disperse the iron oxide powder in the electrolyte after its conveyance by the two screws 38,39 in mild mixing conditions thus avoiding any powder aggregation. These conditions achieve wetting of powder by ensuring maximum exposure to the electrolyte.

The amount of iron oxide powder 46 discharged into the electrolyte 5 is controlled by command means (not depicted) depending on the rate of consumption of the iron oxide by electrolysis.

The barrel 40 is airtight and maintained under nitrogen atmosphere, so that the dry iron oxide powder conveyed by the two screws is airless, thus avoiding any air contact with the electrolyte.

The twin-screw supplier 32 is advantageously arranged parallel to the force of gravitational attraction (vertically) to benefit from gravity assistance for conveying the iron oxide powder into the electrolyte.

Advantageously, the electrolyte feed pipe 31 is perpendicular to the twin-screw supplier 32 and is then horizontally arranged.

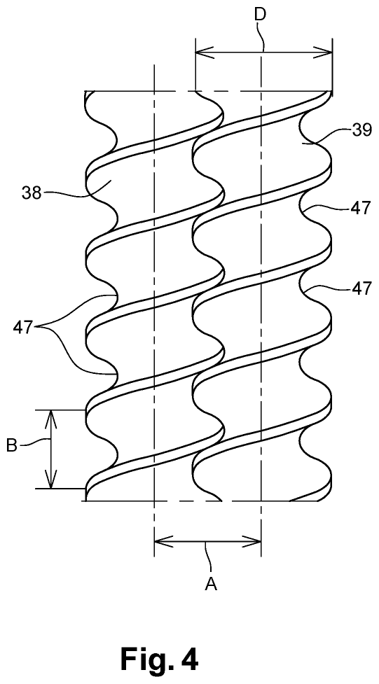

Referring to the FIGS. 3 and 4, the two screws 38,39 are identical for an optimized conjugation. The two screws 38,39 are engaged with each other and maintained parallel to each other at a shaft distance A less than the diameter D of each screw 38,39. The surface of the two screws 38,39 is smooth, preferably prepared by electropolishing. The rotation of the two screws 38,39 in opposite direction allows to finely discharge the iron oxide powder into electrolyte while the two screws 38,39 are self-cleaning. The surface of the screws is thus leaving smooth while avoiding any powder agglomeration. The two screws 38,39 are co-rotating to operate with a small pumping effect thus limiting air vortex. Preferably, the two screws 38,39 are twin-concave coarse screws and the roots 47 of the two screws 38,39 are deep. Advantageously, the ratio between the screw diameter (D) and the screw pitch (B) of each screw (38,39) is from 0.8 to 1.2. Below this range there is a risk of compressing the powder while over it, the pressure it not sufficient for the forward movement of the powder.

What is claimed is:

1-10. (canceled).

11. An apparatus for the production of iron through reduction of iron ore by an electrolysis reaction, the electrolysis reaction emitting a gas, the apparatus comprising:
a casing including a gas-permeable anode plate and a cathode plate facing each other and being separated by an electrolyte chamber; the casing further including a degassing unit including a gas recovery part extending along the opposite side of the gas-permeable anode plate to the chamber, the casing circulating an electrolyte within the electrolyte chamber via an electrolyte inlet and an electrolyte outlet; and
a supply to supply iron ore to the electrolyte chamber, the supply to supply iron ore to the electrolyte chamber including a twin-screw supplier provided to discharge iron ore powder into an electrolyte feed pipe in fluidic connection with the electrolyte inlet, the twin-screw supplier including two screws parallel to each other inside a barrel, maintaining a shaft distance between the two screws and rotating the two screws in opposite directions while the two screws engage with each other, the barrel extending from a screw rotating drive to a discharge opening immersed in the electrolyte flowing through the electrolyte feed pipe, and including an iron ore powder feed opening, the iron ore powder feed opening being connected to iron ore powder feed.

12. The apparatus as recited in claim 11 wherein the two screws are arranged parallel to the force of gravitational attraction.

13. The apparatus as recited in claim 12 wherein the electrolyte feed pipe is arranged perpendicular to the two screws.

14. The apparatus as recited in claim 11 wherein a surface of the two screws is smooth.

15. The apparatus as recited in claim 11 wherein the two screws are twin-concave coarse screws.

16. The apparatus as recited in claim 11 wherein a ratio between a screw diameter and a screw pitch of each of the two screws is between 0.8 to 1.2.

17. The apparatus as recited in claim 11 wherein an internal surface of the barrel is rough and arranged in mechanical contact with the two screws.

18. The apparatus as recited in claim 11 wherein the barrel is under nitrogen atmosphere.

19. The apparatus as recited in claim 11 wherein the iron ore powder feed includes a pinch valve.

20. The apparatus as recited in claim 11 wherein the apparatus is driven by renewable energy.
